(19) United States
(12) Patent Application Publication
(10) Pub. No.: US 2017/0082764 A1
(43) Pub. Date: Mar. 23, 2017

(54) SOURCE CONTROLLER SYSTEM FOR MARINE SEISMIC SOURCE AND METHOD

(71) Applicant: CGG Services SA, Massy Cedex (FR)

(72) Inventors: Joseph LASANTE, Sartrouville (FR); Benoit TEYSSANDIER, Massy (FR)

(21) Appl. No.: 15/306,842

(22) PCT Filed: May 5, 2015
(86) PCT No.: PCT/IB2015/000805

§ 371 Date: Oct. 26, 2016

Related U.S. Application Data
(60) Provisional application No. 62/110,839, filed on Feb. 2, 2015.
(60) Provisional application No. 61/989,001, filed on May 6, 2014.
(60) Provisional application No. 61/988,920, filed on May 6, 2014.

(51) Int. Cl. G01V 1/38; G01V 1/22

(52) U.S. Cl. CPC G01V 1/3861; G01V 1/22; G01V 2200/12; G01V 2200/14

(57) ABSTRACT

A source controller distributed system for a multi-element marine source includes a master controller communicating via a cable with source controllers associated with source elements. The master controller generates commands for the source controllers. Each source controller is attached to sensors and mechanisms of one of the source elements, and controls the source element according to the received commands. The source controller also sends data to the master controllers, with the data being gathered by sensors of the source element and/or being related to the status of the source elements, alerts, and/or functional quality control.

### CROSS REFERENCE TO RELATED APPLICATIONS

The present application claims the benefit of priority under 35 U.S.C. §119 to U.S. Provisional Application No. 61/989,001 filed on May 6, 2014, U.S. Provisional Application No. 61/988,920 filed on May 6, 2014 and U.S. Provisional Application No. 62/110,839 filed on Feb. 2, 2015, the contents of which are hereby incorporated by reference into the present application.

### BACKGROUND

Technical Field

Embodiments of the subject matter disclosed herein generally relate to marine seismic source control and, more particularly, to a distributed system including a master controller and source controllers attached to individual source elements, with the system controlling one or more of initialization, auto-testing, synchronization, pilot playing, quality control and monitoring of a marine seismic source.

Discussion of the Background

Seismic surveys are often employed in the quest to identify hydrocarbon deposits under the seafloor. Marine seismic surveys use seismic sources to send energy waves into the earth. The depth and/or nature of features causing reflections of these waves are evaluated based on time intervals until the reflections are detected. Marine seismic sources frequently include plural individual source elements, which are towed at the water surface or at predetermined depths.

A marine seismic source element may be impulsive, generating a shock (short duration) wave. One of the most used impulsive source elements is an air-gun, which produces a high amount of acoustic energy when compressed air is suddenly released underwater and expands. Waves generated by the air-gun propagate in all directions and their typical frequency range is between 6 and 300 Hz. However, the frequency content of such an impulsive source is not fully controllable, and the use of impulsive sources poses certain safety and environmental concerns.

Alternatively, a marine seismic source element may be vibratory, i.e., a marine vibrator. A marine vibrator generates longer-duration (ranging from a few seconds to continuous) waves than impulsive source elements. The marine vibrator may be hydraulically-powered, electrically-powered or pneumatically-powered and may employ piezoelectric or magnetostrictive materials to generate waves. An advantage of the vibrator is that the frequency spectrum of generated waves is better controlled than for impulsive source elements, with the generated waves being within predetermined frequency bands. One example of such a vibratory source element is described in U.S. Pat. No. 8,837,259, the entire content of which is incorporated herein by reference.

Source arrays including plural individual source elements are now frequently used in marine seismic surveys because, at a long distance from the source (e.g., when penetrating the seafloor), the waves generated by individual source elements combine in a high-energy wave characterized by a source signature. Individual source elements may be towed at a single depth or at variable depths. Dual or multi-level source arrays are also sometimes used to reduce the effect of spectral notches due to destructive interference of the waves with surface reflections.

Sources with plural source elements pose challenges in controlling their operations and associating incident seismic wave information to the seismic data acquired by the sensors detecting reflected waves. Different commands have to be transmitted to actuate differently among the individual source elements. If the individual source elements are marine vibrators, each individual source element generates a train of waves according to a pilot signal. Although a pilot signal may be pre-programmed, adjustments may become necessary because the status of other individual elements may change. On the other hand, it would be desirable to receive data from the individual source elements to monitor their operation, to evaluate the source signature, and to associate the signature with the seismic data acquired by receivers.

Thus, there is a need to provide a marine source control system able to operate and monitor a source array efficiently.

### SUMMARY

Control of marine seismic sources including plural source elements is ensured by a distributed control system that includes source controllers of the source elements and a master controller. Source controllers operate the source elements based on individual commands generated by the master controller and gather sensor and status data. The master controller aggregates the sensor and status data received from the source controllers. The master controller may include an operator interface, and may supply source-related information (e.g., an estimated source signature) to the data acquisition system that records the seismic data related to reflected waves.

According to an embodiment, there is a source control distributed system including a master controller and source controllers. The master controller is configured to generate commands for source controllers associated with source elements deployed underwater, to send the commands via a cable to the source controllers, to receive data from the source controllers, to aggregate the data received from the source controllers. Each source controller is attached to sensors and mechanisms of one of the source elements and is configured to receive the commands via the cable from the master controller, to control the one of the source elements by actuating the mechanisms according to the received commands, to gather first data from the sensors, to generate second data related to status of the one of the source elements, alerts, and/or functional quality control thereof, and to send the first and second data to the master controller.

According to another embodiment, there is a master controller including a communication interface and a processing unit. The communication interface is configured to send commands via a cable to source controllers associated with source elements of the marine seismic source, and to receive data from the source controllers. The processing unit is connected to the communication interface and configured to generate the commands and to aggregate the data received from the source controllers.

According to yet another embodiment, there is a source controller configured to be attached to or embedded in a source element of a marine seismic source deployed underwater. The source controller includes a communication interface and a processing unit. The communication interface is configured to receive commands via a cable from a master controller, and to send data to the master controller. The processing unit is connected to the communication interface, sensors and mechanisms of the source element. The source controller is configured to control the source element by actuating the mechanisms according to the received commands, to acquire a subset of the data from the sensors and to generate another subset of the data related to status of the source element, alerts, and/or functional quality control thereof.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is schematic diagram of a marine seismic survey system according to an embodiment;

FIG. 2 illustrates a marine seismic source with plural sub-arrays and plural air-guns;

FIG. 3 is a diagram of a distributed source control system according to an embodiment;

FIG. 4 is a master controller according to an embodiment;

FIG. 5 is a source controller according to an embodiment;

FIG. 6 is flowchart of processes performed by a source controller according to an embodiment;

FIG. 7 is a schematic diagram of a twin transducer; and

FIG. 8 is a flowchart of a method for controlling a marine source including plural source elements, according to an embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed using the terminology and structure of a vibratory or air-gun source that includes plural individual source elements configured to generate acoustic energy in a marine environment. However, the features discussed in this section are not limited to marine sources, but they may be applied to any type of multi-element source whose elements can be independently controlled to achieve a desired output beam (i.e., direction, time and frequency of an emitted seismic wave).

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

In order to efficiently control a source with plural source elements, a source control distributed system is employed. According to one embodiment, the source control distributed system has a master controller and source controllers embedded in or attached to the source elements, which are deployed underwater during marine seismic surveys. The master controller is configured to generate commands for the source controllers, to send the commands via a cable to the source controllers, to receive data from the source controllers, and to aggregate the data received from the source controllers. Each source controller is connected to sensors and mechanisms of a source element, and is configured to receive commands from the master controller, to control the source element by actuating the mechanisms according to received commands, to gather data from the sensors, to generate data related to the status of the source element, alerts, and/or functional quality control thereof, and to send the data to the master controller.

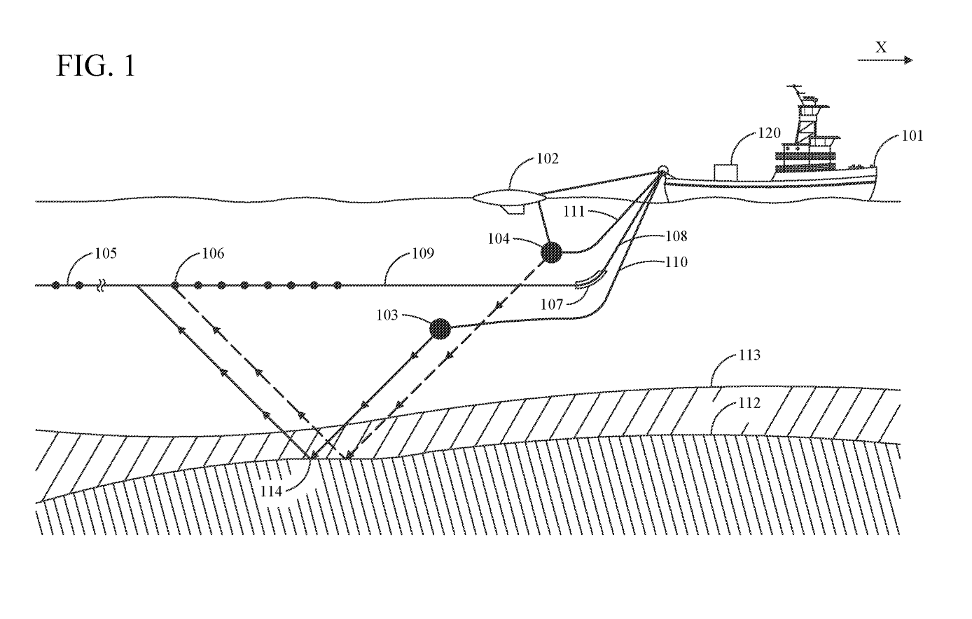

FIG. 1 illustrates data acquisition during a marine seismic survey according to an embodiment. A vessel 101 tows a float 102 that can be steered at the sea surface. Two sub-sources 103 and 104 are suspended from float 102 (or from different floats) at fixed, different depths. Sub-sources 103 and 104 include one or more individual source elements (e.g., vibrators). Sub-source 103 may be a low-frequency vibratory source (e.g., emitting waves within a 5-25 Hz band) deployed, for example, at about 20 m. Sub-source 104 may be a high-frequency vibratory source (e.g., emitting waves within a 25-125 Hz band) towed at a shallower depth than sub-source 103, for example, at about 5 m. The sub-sources and/or the individual source elements are controlled by a distributed source controller system described in detail below. Part of this system, a master controller 120 may be located on vessel 101 and communicate with sub-sources 103 and 104 via cables 110 and 111. Cables 110 and 111 may also be configured to supply power to the sub-sources.

Vessel 101 may also tow a streamer 105 that houses multiple receivers 106 (typically hydrophones) that detect reflected waves. A diverter 107 may be used to pull the streamer at the prescribed operating depth, and the streamer may be attached to the vessel through a lead-in cable 108. A stretch section 109 may be located on the streamer ahead of the receivers and configured to mitigate tow noises and reduce jerk forces (i.e. occasional variations of the tow or tension forces between the vessel and the streamer). Note that the sub-sources and the streamer(s) may be towed separately by different vessels. Also note that rather than a float, a submerged header equipped with control surfaces (fins) could be used to tow and steer the sub-sources, with such a header better mitigating noise and source depth variations due to swells.

A wave (or train of continuous or semi-continuous waves) emitted from sub-source 103 (or 104) propagates through the water, passes through seafloor 113 and may strike a reflector (e.g., a layer interface 112 between a silt layer and a rock layer) in the underground formation. A portion of the incident energy is then reflected back toward the water surface and propagates back through seafloor 113 and the water to be detected by a receiver 106. A receiver transducer converts the detected acoustic energy into electrical energy that is sampled by an A/D converter into a numeric value. The resulting digital data is multiplexed with data from other receivers, and receiver data is transmitted through streamer 105 to a seismic data acquisition system (not shown) onboard vessel 101. The seismic data acquisition system integrates information about the emitted energy provided by master controller 120 with the receiver data.

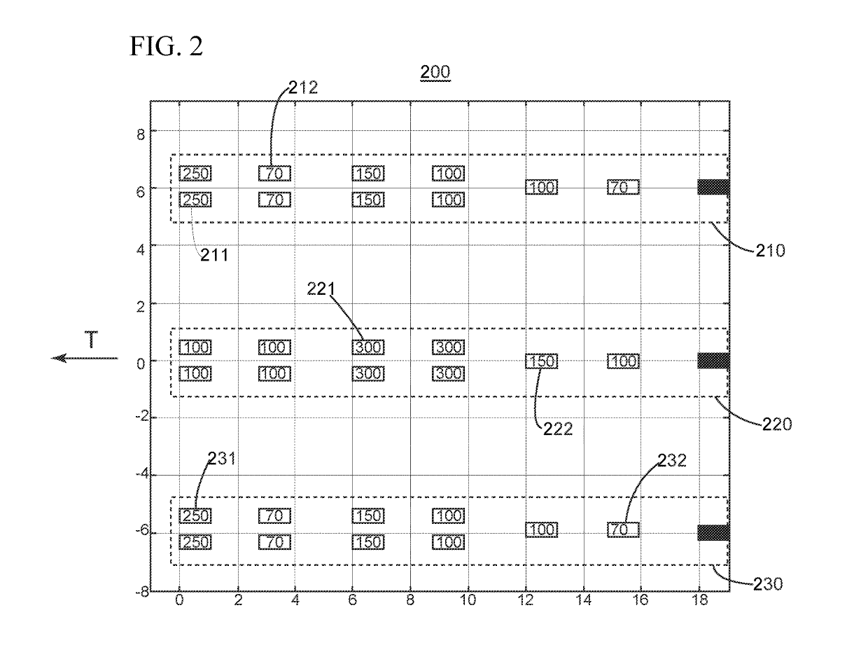

FIG. 2 is a bird's-eye view (i.e., in a substantially horizontal plane) of a marine source 200 including three sub-arrays, 210, 220 and 230 at a same depth. A sub-array is a physical subdivision of a source, which is towed individually. Achieving and maintaining sub-arrays and/or individual elements' arrangement has a substantial impact on the emitted beam. Although the individual source elements (e.g., 211, 212, 221, 222, 231, 232, only a few are labeled in FIG. 2) are actuated substantially at the same time, their distinct positions yield delay of the individual wave-fronts and, therefore, actuation has to occur at an individual time and/or with an individual phase (in case of vibrators) for each source element.

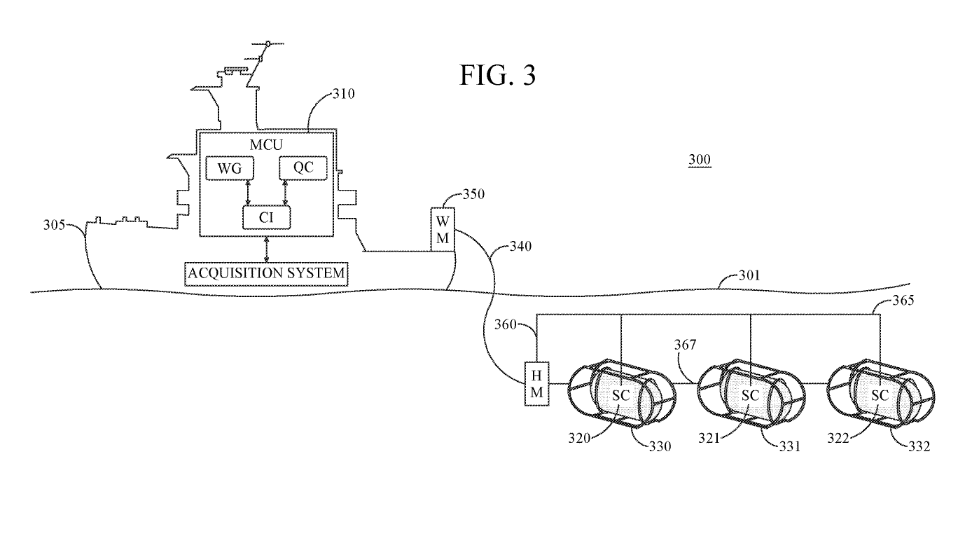

According to an embodiment, a distributed source control system 300 for controlling a marine seismic source (e.g., 103, 104, 200 in FIGS. 1 and 2) including plural individual source elements is illustrated in FIG. 3. System 300 includes a master control unit (MCU) 310 and source controllers (SC) 320, 321, 322 embedded in source elements 330, 331, 332 (the number and arrangement of the source controllers are exemplary and not intended to be limiting). In FIG. 3, the source elements are submerged under the water surface 301, and MCU 310 is located on towing vessel 305. Source controllers may be built in the source elements or may be attached to the source elements prior to deployment. As illustrated in FIG. 3, MCU may include a module pilot wave generator (WG), a quality control module (QC) that may estimate source's far field signature, and a control interface (CI) for a dashboard.

Commands and data are communicated between MCU 310 and the source controllers 320, 321, 322 via cable 340. When the source elements are deployed or recovered, cable 340 may be released from or rewound on a winch module (WM) 350. Cable 340 may perform other functions (in addition to enabling communication between MCU and source controllers) such as intermediating towing force transfer, providing power to the source elements, etc. Cable 340 may be connected to a header module (HM) 360, which may separate a data communication pathway 365 from a power supply line 367.

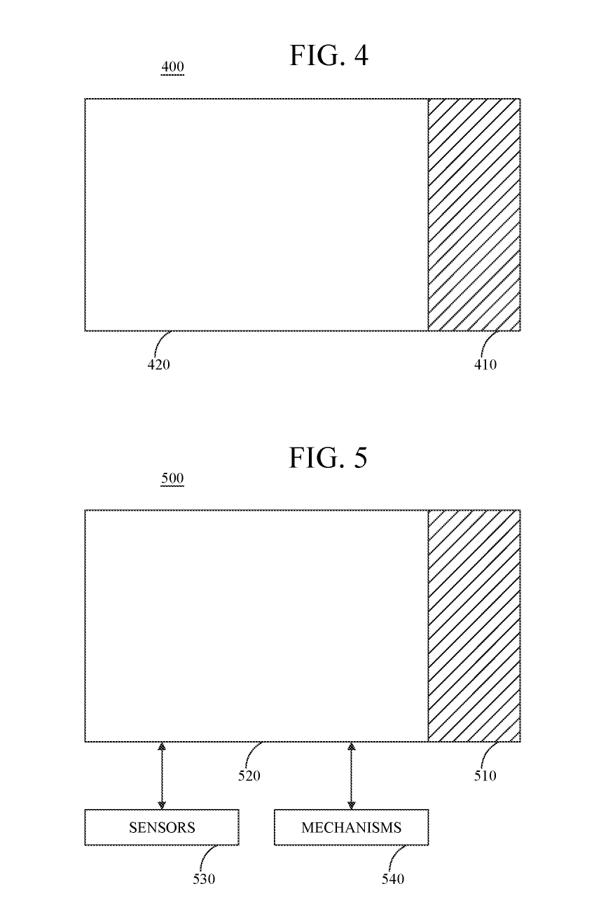

FIG. 4 schematically illustrates a master controller 400 (which may be an embodiment of MCU 310 or master controller 120), which includes a communication interface 410 and a processing unit 420. Interface 410 is configured to send commands via a cable to source controllers (not shown) and to receive data from the source controllers. Processing unit 420 includes one or more processors and is connected to interface 410. Processing unit 420 is configured to generate commands for the source controllers and to aggregate data received from the source controllers. The commands may direct the source controllers to perform one or more processes of initialization, auto-tests, calibration, and/or synchronization, etc. Data received from the source controllers includes status, alerts, functional quality control and/or sensor data, etc.

The commands include individual actuating commands related to actuating each source element. These actuating commands are different for the different source elements. If the source elements are vibrators, such an individual command may include start time, gain, and/or phase, etc., making the source elements vibrate according to pilot signals. If the source elements are air-guns, an individual command includes at least an actuation time.

The commands may also include initialization commands that trigger setup of the source elements individually and/or may set up general parameters related to a source's operation (e.g., commands related to the arrangement of the sub-arrays or to individual source elements).

The commands may also include synchronization commands enabling synchronization of a master controller time with times used by the source elements, and/or auto-testing commands that trigger auto-testing of the source elements (as discussed in more detail later in this document).

Processing unit 420 may further be configured to calculate an estimated far-field signature of the marine seismic source based on data received from the source controllers and/or actuating commands.

Master controller 400 may include or communicate with an operator interface configured to display at least part of the aggregated data and/or to receive instructions from an operator. The processing unit then generates commands according to the instructions.

Communication interface 410 may further be configured to store and/or transmit at least a subset of the aggregated data and/or other information related to the seismic survey. For example, the other information may include the estimated source signature that is transmitted in a predetermined format to the seismic data acquisition system. In another example, the other information may be relevant to navigation and data acquisition sub-systems.

Communication interface 410 may also be configured to communicate with the source controllers via a safety bus, enabling communication between the master controller and the source controllers via a different channel when communication via the main channel (associated with the cable) fails.

According to another embodiment, a source controller 500 configured to be attached to or embedded in a source element of a marine seismic source deployed underwater is illustrated in FIG. 5. Source controller 500 includes a communication interface 510 connected to a processing unit 520. Communication interface 510 is configured to receive commands via a cable from a master controller (not shown in FIG. 5), and to send data to the master controller. Processing unit 520 is connected to sensors 530 and mechanisms 540 of the source element. Processing unit 520 is configured to control the source element by actuating the mechanisms according to received commands, to acquire a subset of the data from the sensors, and to generate another subset of the data related to the status of the source element, alerts, and/or functional quality control related to the source element.

The source controller may also be configured to generate packets from the data (sensor data and other information), to associate a time stamp with each of the packets, and to assign different priorities to the packets. This manner of operation enables critical data management, which is discussed later in this document. Data provided by a source controller to the master controller may include (depending also on the type of source element) one or more of: temperature, acceleration and displacement of a vibrating part (e.g., piston), voltage, current, water ingress, pressure, position, etc.

Data processing unit 520 may be configured to control execution of one or more of the following processes, according to received commands: initialization, auto-tests, actuation, quality control, and synchronization.

An initialization process may consist of setting up all the source elements and setting up general parameters. Setting up all the source elements may include initializing parameters related to a number of array levels and sub-arrays at each level, number and arrangement of the source elements in sub-arrays, other technical characteristics and identification of individual source elements. Setting up general parameters may include specifying a desired synchronization time and accuracy, the type of survey (e.g., for vibrators, cyclical playing or continuous playing), or maximum play duration for continuous playing.

An auto-test process at a source controller may include one or more of: power supply checking, emergency stop activation/deactivation, protection circuit activation/deactivation, isolation sequence (i.e., disconnect a source element and activate a spare one), testing power chain and data acquisition chain, checking a pneumatic system and synchronization protocol. Once some or all auto-tests are successfully completed and reported to the master controller, the master controller may send a “Source System Ready” signal to the navigation system.

A synchronization process aims to have the same time reference at the master controller and source controllers. The master controller may set a reference time based on a Global Positioning System (GPS) signal. Each controller has a reference clock (e.g., a 10 MHz clock with 15 ppb stability). Synchronization may be achieved in two steps. A first step ensures that the source controllers have “universal second” and may be implemented using a standard protocol IEEE 1588 V2 (which automatically takes into account the delay in transmitting the synchronization commands to different source controllers). A second step achieves more precise synchronization using a synchronization signal (PPS SYNC) able to ensure higher precision (e.g., 10 μs).

If the source elements are vibrators, the source controllers receive a pilot signal (called simply “pilot”) and make the vibrator vibrate according to this signal (action known as “pilot playing”) and thus emit energy. As is known in the art, the vibrators may be operated periodically for a few seconds in a cyclical survey (using sweeps) or continuously for a continuous-emission survey (using random or pseudo-random sequences). The source controller is configured to identify and select the actuation command for the source element it controls.

If a cyclical survey is performed, the source controller then actuates the vibrator's motor (which is one of the source element's mechanisms) to play the pilot (i.e., waveform) indicated in the actuation command with the gain and the phase shift also specified in the command. The source controller then gathers sensor data related to the energy emission and transmits this data together with respective time-stamps to the master controller. As described above, the master controller receives signals from the source controllers and can compute in real time or off-line some Quality Control (QC) computations such as calculating the vertical far-field signature. This estimated signature can be shared with the data acquisition system so that data can be processed properly. Furthermore, in order to ensure QC, the estimated far-field signature may be compared to another estimated far-field signature based on a pulse compression using knowledge about the pilots (cross-correlation process) to identify and assess the quality of the source generated wavelet, which can be considered as the input signal in seismic imaging after pulse compression.

If the energy emission is continuous, the source controller then actuates the vibrator's motor to play a pilot (waveform) specified in the command continuously until the maximum play time specified in the actuation command elapses or an operator command directs stopping the vibrator before the maximum play time ends.

The source controllers may also be configured to perform a monitoring process. This monitoring process is exercised during startup, operation, restart and shutdown of the source elements according to a survey plan. The monitoring process asserts a source element's status, detects failures, issues alarms, and takes appropriate source element control actions in case of failure. A quality control process may focus on beam quality so that when beam quality degrades, it may assist in identifying the cause and taking corrective or adaptive action. The source controller may generate orders and requests to safely stop the source element, to activate a spare source element (applying a backup survey design plan), increase the emitted energy, etc.

The master controller may allow creating, editing, monitoring, retrieving and displaying results of monitoring. Based on data received from source controllers, the master controller is able to display for an operator the configuration and status of the source elements or of an individual source element. When a source element's failure occurs, the master controller may automatically or upon receiving instructions from the operator access detailed information about the element causing failure, access historical information related to the failing element, and/or generate a maintenance request. The master controller may also maintain an alert management dashboard.

The objective of monitoring, quality control and source signature estimation is to have as much as possible the same far-field signature (resulting from combining the wave emissions of all source elements) during the seismic survey. The master controller may be configured to estimate the source signature using (i) data received from source controllers, (ii) design parameters of the source elements, and (iii) parameters adjusted for instantaneous conditions (such as wave propagation velocity). If the source elements are actuated cyclically or at predetermined times, the source signature may be estimated cycle-by-cycle or shot-by-shot. In the case of a continuous activation, the source signature may be evaluated periodically.

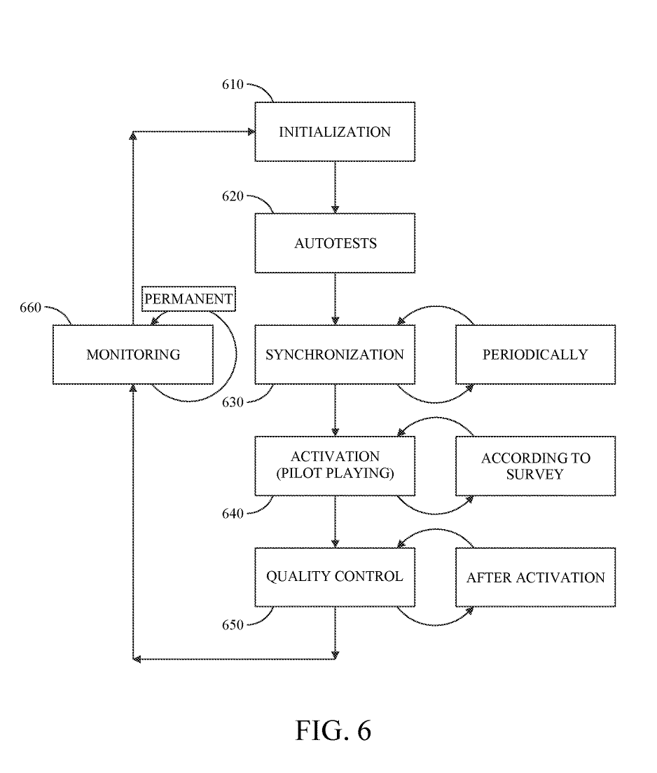

A flowchart of processes that may be performed by a source controller according to an embodiment is illustrated in FIG. 6, where time flows from the top to the bottom. Initialization 610 and auto-testing 620 may occur at the beginning of a survey or when restarting is performed. Synchronization 630 occurs periodically, e.g., once every minute. Activation 640 (e.g., pilot playing) occurs according to the survey plan. Quality control 650 is performed after each source activation. Monitoring 660 is permanent, in the sense that it is performed throughout the survey.

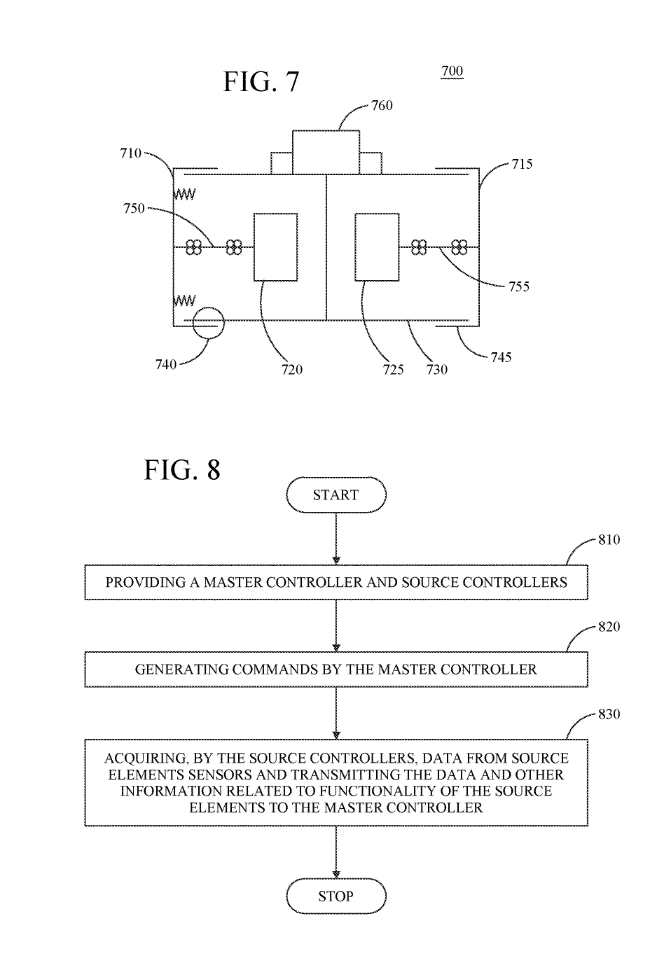

In a marine source having plural sub-arrays of vibrators, each sub-array includes a winch module, an umbilical, a head module and a number of vibrators connected in series (i.e., one after another along the umbilical). The vibrators may be single transducers or twin transducers. A schematic diagram of a twin transducer 700 is illustrated in FIG. 7. Twin transducer 700, which is capable of emitting acoustic energy over a low-frequency band (e.g., 5-25 Hz) and over a high-frequency band (e.g., 25-125 Hz), has two pistons 710 and 715. The waves are generated due to the back-and-forth pistons' motion. The pistons move due to force delivered by actuators 720 and 725 housed inside enclosure 730. Piston seals 740 and 745 allow piston motions but prevent water flooding inside enclosure 730. Guiding systems 750 and 755 prevent non-axial motion of pistons 710 and 715, respectively, and limit the piston stroke (i.e., range of the back-and-forth motion). Local power unit 760 delivers power to the actuators according to the pilot.

Since along the same umbilical may be numerous vibrators (e.g., 8-10 twin transducers), the volume of data sent from the source controllers to the master controller may become large, and critical data (e.g., alarms) may be delayed. Therefore, a priority-based mechanism for selectively forwarding high-priority packets submitted by source controllers to the master controller is put in place.

The mechanism for critical data management may be implemented by intercalating a switch 1588 (i.e., compliant to IEEE 1588 V2) in the data flow between the source controllers and the master controller. The switch may be located in the head module. This switch preferentially and ahead of the chronological order forwards the highest priority packets to the master controller.

In one embodiment, data management may have an additional layer implemented, e.g., using additional Ethernet boards (compliant to IEEE 802.3). This additional layer of data management selects and directs a subset of the packets to a predetermined module. For example, quality control data is forwarded to a source signature estimation module, or alarms/alerts for specific sub-arrays or source elements to be handled faster than the rest of alarms/alerts. This additional mechanism enables channeling information to operators with dedicated roles: an operator who handles source activation, an operator who manages quality control, an operator who monitors critical/failing source elements, etc.

The distributed control system may include a mechanism for backup communication, to be used in case communication via cable fails. In one embodiment, the mechanism includes a safety bus allowing a low data rate exchange between the master controller and the source controllers. This communication channel may be used by the source controllers to transmit status/alarms data and by the master controller to transmit emergency commands. This channel may be implemented using an RS485 bus (compliant to ANSI/TIA/EIA-485 for RS485) or a CAN bus (compliant to ISO 11898).

The RS485 bus can be used in two-wire systems (half-duplex operation) or in four-wire systems (full-duplex operation). The RS485 transmitter's tri-state capability allows the connection of multiple source controllers to a two-wire bus. In half-duplex operation, the RS485 bus allows only one driver to talk at any given time. In this configuration, a fault conditions situation might occur as a result of a bus contention. Therefore, RS485-compliant devices must be able to handle this type of failure. In full-duplex operation, two twisted pairs provide a more robust implementation in which the master controller may initiate communication with up to 32 source controllers. Currently, a maximum recommended cable length is 1,200 m for a bandwidth of 10 Mb/s. The noise level and bus bandwidth limit the cable length. Such a configuration may achieve a rate of 460 Kbits/s.

In another embodiment, the safety bus may be a TCP/IP connection similar to the main communication channel. This safety bus may be simpler than the main channel by having a basic IP switch in the head module (not a 1588 switch able to selectively forward packets in an order modified based on priority from the chronological order of receiving packets), and by having no redundancy between the winch module and the head module (and thus not requiring a switch in the winch module).

The safety bus may be part of a sub-system of the distributed source control system, which sub-system is able to operate up to 30 minutes without power. The sub-system also includes low-power processing units in the master controller and the source controllers working with power provided by rechargeable batteries (maintained full during regular operation). This sub-system ensures a degraded mode source operation in case of emergency (and even power cut) to put the head module and the source elements in a safe state. An advantage of this solution is that an IP connection similar to the main communication (with the same protocol) can be used.

A flowchart of a method 800 for controlling a marine source including plural source elements is illustrated in FIG. 8. Method 800 includes providing a master controller and source controllers, at 810. The master controller is configured to generate commands for source controllers associated with the source elements, to send the commands via a cable to the source controllers, and to receive data from the source controllers. Each of the source controllers is connected to sensors and mechanisms of one of the source elements and is configured to receive commands via the cable from the master controller, to control one of the source elements by actuating the mechanisms according to received commands, to acquire first data from the sensors, to generate second data related to the status of one of the source elements, alerts, and/or functional quality control thereof, and to send the data including the first and second data to the master controller.

Method 800 further includes generating commands by the master controller, at 820. The commands are related to at least one of initializing the source elements individually and/or setting general parameters related to operating the marine seismic source, auto-testing related to functionality of the marine seismic source, synchronizing the master controller and the source controllers at a predetermined time precision, and actuating the source elements to generate seismic waves, with the commands being transmitted to the source controllers via a cable.

Method 800 also includes acquiring, by the source controllers, data from source elements sensors and transmitting the data and other information related to the source elements' functionality to the master controller, at 830. The commands are generated taking into consideration the data and the other information.

Accordingly, the master controller and source controllers may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer-readable medium may be utilized, including hard disks, CD-ROMs, digital versatile discs (DVD), optical storage devices or magnetic storage devices such a floppy disk or magnetic tape. Other non-limiting examples of computer-readable media include flash-type memories or other known types of memories.

Some of the above-disclosed embodiments provide the following features and advantages:
triggering auto-tests of electronic/pneumatic/power components of the source elements before and/or after deployments in the water;
troubleshooting capabilities enhanced by monitoring, quality control and local analysis of the auto-tests' results;
management of security procedure and safety function in case of emergency power cut, managing pressure and generating alarms if necessary;
providing a dashboard to an operator to support decision-making and operation management;
having a single master clock based on GPS distributed to synchronize the controller with high precision (e.g., 10 μs);
adaptive command-control such as sending a dedicated pilot to each marine vibrator, individual gain according to position of the vibrator, and dedicated phase shift to achieve a desired illumination (beam);
real-time reconfiguration to adapt to individual element failure(s) and weather conditions;
providing an estimated far-field source signature calculated using data received from the source controllers such as accelerometer vectors, source elements' positions, water celerity, salinity and temperatures.

The disclosed embodiments provide a distributed source control system, master controllers and source controllers for controlling a multi-elements marine source. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A source control distributed system, comprising:
a master controller configured to generate commands for source controllers associated with source elements deployed underwater, to send the commands via a cable to the source controllers, to receive data from the source controllers, and to aggregate the data received from the source controllers; and
the source controllers, each of which is attached to sensors and mechanisms of one of the source elements and is configured to receive the commands via the cable from the master controller, to control the one of the source elements by actuating the mechanisms according to the received commands, to gather first data from the sensors, to generate second data related to status of the one of the source elements, alerts, and/or functional quality control thereof, and to send the first and second data to the master controller.

2. The source control distributed system of claim 1, wherein the source controllers are configured to send the first and second data in packets and to assign a priority to each of the packets, the priority depending on type of data in the packet,
the system further comprising a switch intercalated in a path of the packets from the source controllers to the master controller, the switch being configured to process and forward the packets to the master controller in an order depending on the priority.

3. The source control distributed system of claim 1, further comprising:
a safety bus configured enable communication between the master controller and the source controllers when communication via a main channel associated with the cable fails.

4. A master controller of a marine seismic source, the master controller comprising:
a communication interface configured to send commands via a cable to source controllers associated with source elements of the marine seismic source, and to receive data from the source controllers; and
a processing unit connected to the communication interface and configured to generate the commands and to aggregate the data received from the source controllers.

5. The master controller of claim 4, wherein the processing unit is further configured to perform an initialization to setup the source elements individually and/or to setup general parameters related to operating the marine seismic source.

6. The master controller of claim 4, wherein the processing unit is configured to generate the commands to trigger auto-testing of the source elements.

7. The master controller of claim 4, wherein the processing unit is configured to generate the commands to synchronize the master controller and the source controllers at a predetermined time precision.

8. The master controller of claim 4, wherein
the source elements are vibrators, and
the processing unit is configured to generate the commands that make the source elements to vibrate according to pilot signals, one individual command among the commands being generated for each of the source elements.

9. The master controller of claim 4, wherein the processing unit is configured to calculate an estimated far-field signature of the marine seismic source based on the data and/or a subset of the commands triggering the source controllers to actuate the source elements.

10. The master controller of claim 4, further comprising:
an operator interface connected to the processing unit and configured to display at least a part of the aggregated data and/or to receive instructions from an operator, the processing unit then generating at least one of the commands according to the instructions.

11. The master controller of claim 4, wherein the communication interface is further configured to store and/or transmit at least a subset of the aggregated data, and/or other information related to a seismic survey.

12. The master controller of claim 4, wherein the communication interface is configured to communicate with the source controllers via a safety bus enabling communication between the master controller and the source controllers when communication via a main cannel associated with the cable fails.

13. A source controller configured to be attached to or embedded in a source element of a marine seismic source deployed underwater, the source controller comprising:
a communication interface configured to receive commands via a cable from a master controller, and to send data to the master controller; and
a processing unit connected to the communication interface, sensors and mechanisms of the source element, and configured to control the source element by actuating the mechanisms according to the received commands, to acquire a subset of the data from the sensors and to generate another subset of the data related to status of the source element, alerts, and/or functional quality control thereof.

14. The source controller of claim 13, wherein the processing unit is further configured to generate packets from the data, to associate a time stamp to each of the packets, and to assign different priorities to the packets.

15. The source controller of claim 13, wherein the processing unit is configured to control execution of one or more of following operations, according to the received commands: initialization, auto-tests, calibration, and synchronization.

16. The source controller of claim 13, wherein the individual source element is a marine vibrator and the data processing unit is further configured to maintain a predetermined pressure within the marine vibrator during deployment, operation and recovery of the individual source element.

17. The source controller of claim 13, wherein the data processing unit is further configured to control the individual source element to generate seismic waves according to a pilot signal included in one of the commands.

18. The source controller of claim 13, wherein the communication interface is configured to communicate with the master controller via a safety bus when communication via a main channel associated with the cable fails.

19-20. (canceled)
